(19) United States
(12) Patent Application Publication
(10) Pub. No.: US 2026/0060255 A1
(43) Pub. Date: Mar. 5, 2026

(54) METHOD FOR PREPARING ORGANIC QUATERNARY AMMONIUM COMPOUND MODIFIED CLAY FOR ENVIRONMENTALLY FRIENDLY AND EFFICIENT ALGAE REMOVAL

(71) Applicant: Institute of Oceanology, Chinese Academy of Sciences, Qingdao Shandong (CN)

(72) Inventors: Xihua Cao, Qingdao Shandong (CN); Mingjiao Wang, Qingdao Shandong (CN); Zhiming Yu, Qingdao Shandong (CN); Xiuxian Song, Qingdao Shandong (CN); Xu Zheng, Qingdao Shandong (CN)

(21) Appl. No.: 19/384,579

(22) Filed: Nov. 10, 2025

(30) Foreign Application Priority Data
Nov. 12, 2024 (CN) 202411606659.1

(51) Int. Cl. A01N 55/00; A01N 25/08; A01P 13/00

(52) U.S. Cl. CPC A01N 55/00; A01N 25/08; A01P 13/00

(57) ABSTRACT

A method for preparing an organic quaternary ammonium compound modified clay for environmentally friendly and efficient algae removal. After hydroxyl activation treatment is performed on a surface of a raw clay mineral, a silyl-containing organic quaternary ammonium compound (Si-QAC) modifier is added. By regulating a covalent bonding reaction between the silyl in a modifier molecule and an active site on a clay surface, the directional anchoring of the modifier on the clay surface is realized, thereby obtaining an organic quaternary ammonium compound modified clay material with high stability, good ecological safety, and efficient removal capability for common harmful algal blooms.

### TECHNICAL FIELD

The present disclosure belongs to the field of harmful algal bloom prevention and control, and particularly provides a method for preparing an organic quaternary ammonium compound modified clay for environmentally friendly and efficient algae removal.

### BACKGROUND

Harmful Algal Blooms (HABs), also known as red tide, are ecological anomalies caused by the explosive proliferation or accumulation of microorganisms in seawater. As a global marine ecological disaster, the HABs pose a great threat to coastal ecological safety, economic development, and human health, and are listed as one of the existing three major coastal environmental problems by relevant environmental organizations of the United Nations. Under the influences of human activities and global changes, the disaster-causing species of the HABs and the ways of causing harm are increased, and the trend of increasing harm is still rising. According to incomplete statistics, there are more than 2000 human poisoning incidents caused by red tide in the world every year, with a mortality rate of 15%. China is one of the countries with the most serious red tide harm in the world. Every year, red tide occurs more than 70 times, resulting in economic losses of up to 30 billion yuan. In order to protect coastal ecological safety, economic development, and human health, safe and efficient red tide prevention and control measures are urgently needed.

The red tide control technology with a Modified Clay (MC) is currently the only on-site emergency treatment method for red tide applied on a large scale at home and abroad. At present, this technology has been successfully applied in more than 20 sea areas from south to north in China, and has become an important technical guarantee for harmful red tide control in major activities, sensitive sea use, and important economic development areas. In 2017, this technology was applied abroad for the first time. Since then, it has been exported to the United States, Chile, and other countries, and has become an HAB control method widely recognized at home and abroad.

Up to now, a series of types of modified clays such as an inorganic modified clay, an organic modified clay, a microbial modified clay, and a composite modified clay have been developed for different control application scenarios. An organic quaternary ammonium compound modified clay (QAC-MC) has the characteristics of low dosage and high algae removal efficiency, and shows good applicability in fine treatment of aquaculture water and the like. However, the adsorption of a common organic quaternary ammonium compound (QAC) modifier on the clay surface is achieved mainly through physical effects such as electrostatic interaction, van der Waals force, and hydrophobic interaction. The QAC modifier has poor adsorption stability, and is easy to lead to the modifier's desorption from the clay surface, which in turn affects the stability and ecological safety of the QAC-MC. Therefore, there is an urgent need to develop a modification method with organic quaternary ammonium compounds that can stably bind to the clay surface and be quantitatively controlled, so as to provide a type of modified materials with higher stability and better ecological safety for the efficient control of the HABs.

### SUMMARY

In view of the problems of poor stability and unsatisfactory ecological safety of existing organic quaternary ammonium compound modified clays, an objective of the present disclosure is to provide a method for preparing an organic quaternary ammonium compound modified clay for environmentally friendly and efficient algae removal for controlling HABs.

To achieve the above objective, the present disclosure adopts the following technical solutions.

A method for preparing an organic quaternary ammonium compound modified clay for environmentally friendly and efficient algae removal includes: performing hydroxyl activation treatment on a surface of a raw clay mineral, and then adding a silyl-containing organic quaternary ammonium compound (Si-QAC) modifier; and obtaining an organic quaternary ammonium compound modified clay by regulating a covalent bonding reaction between the silyl in a modifier molecule and an active site on a clay surface.

The covalent bonding reaction between the silyl in the modifier molecule and the active site on the clay surface refers to a reaction of a mixture of the raw clay mineral and the silyl-containing organic quaternary ammonium compound modifier (g:mmol) in a ratio of 5:(0.3 to 30) for 6 to 24 hours under a heating condition of 40° C. to 80° C. after the hydroxyl activation treatment on the surface of the raw clay mineral.

The silyl-containing organic quaternary ammonium compound (Si-QAC) modifier includes a silicon-containing group, aliphatic hydrocarbyl, and a nitrogen-containing group.

A structural formula of the silyl-containing organic quaternary ammonium compound (Si-QAC) modifier is as shown by a general formula I,

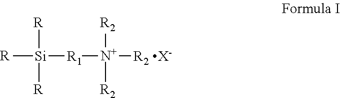

where R is C1 to C20 alkoxy or C1 to C20 haloalkoxy; R₁ is C1 to C20 alkyl, C1 to C20 alkoxy, C1 to C20 haloalkoxy, C1 to C20 acyl, or C1 to C20 alkoxycarbonyl; R₂ is H, C1 to C20 alkyl, or C1 to C20 alkoxy; and X⁻ is an anion.

Preferably, R is C1 to C4 alkoxy; R₁ and R₂ are each C1 to C6 alkyl; and X⁻ is a halide anion such as F⁻, Cl⁻, Br⁻, and I⁻.

The hydroxyl activation treatment on the clay surface refers to acid or alkali treatment on the clay mineral, or introducing a compound containing active hydroxyl on the clay surface.

The acid or alkali treatment refers to placing the clay mineral in an acid or alkali solution, reacting with shaking for 1 hour or longer at normal temperature or under a heating condition, and then centrifugally washing with ethanol and drying.

The acid solution is prepared from an inorganic acid; and the alkali solution is prepared from one or more of a hydroxide, an oxide, or a salt of an alkali metal or an alkali earth metal.

The acid or alkali treatment includes: mixing a raw material kaolin and the acid or alkali solution in a mass ratio of 1:2 to 1:50, and then reacting.

The introducing a compound containing active hydroxyl on the clay surface includes: uniformly dispersing the clay mineral in a mixed solution containing absolute ethanol, ammonium hydroxide, and water by ultrasound, slowly adding dropwise a silicon-based precursor capable of reacting to generate the compound containing active hydroxyl to the mixed solution under conditions of heating at 40° C. to 80° C. and stirring, and reacting completely, where a mass ratio of the clay mineral to the silicon-based precursor is 5:1 to 5:50; and the silicon-based precursor is prepared from one or more of silanol, siloxane, and a silicate, preferably Tetraethyl Orthosilicate (TEOS).

The clay mineral is an aluminosilicate mineral. The clay mineral is, for example, kaolin, montmorillonite, illite, attapulgite, halloysite, or a mixture of two or more of them.

Provided is an organic quaternary ammonium compound modified clay for environmentally friendly and efficient algae removal prepared by the method described above, where the organic quaternary ammonium compound modified clay with high stability and good ecological safety is prepared by the method.

Provided is use of the organic quaternary ammonium compound modified clay for environmentally friendly and efficient algae removal, where the organic quaternary ammonium compound modified clay is used for the removal of harmful algal blooms in an environment.

According to the method for preparing an organic quaternary ammonium compound modified clay for environmentally friendly and efficient algae removal, after the hydroxyl activation treatment is performed on the surface of the aluminosilicate mineral clay, the silyl-containing organic quaternary ammonium compound (Si-QAC) modifier is added. By regulating the covalent bonding reaction between the silyl in the modifier molecule and the active site on the clay surface, the directional anchoring of the modifier on the clay surface is realized, thereby obtaining an organic quaternary ammonium compound modified clay material with high stability, good ecological safety, and efficient removal capability for common HABs.

The present disclosure has the following advantages and positive effects.

The present disclosure has the following advantages: the molecular valence bond action between the silyl in the Si-QAC molecule and the active site on the clay surface is utilized to realize the accurate regulation and strong bonding of grafting modification of the organic quaternary ammonium compound molecules on the clay surface. A composite material which not only can efficiently remove algae but also has high stability performance is obtained, and a new method is provided for accurately synthesizing the organic quaternary ammonium compound modified clay with good ecological safety.

### BRIEF DESCRIPTION OF THE DRAWINGS

FIG. 1 is a diagram showing a comparison on removal efficiency for Heterosigma akashiwo between silyl-containing organic quaternary ammonium compound (Si-QAC) modified clays prepared by different surface hydroxyl activation methods provided in Example 1 of the present disclosure.

FIG. 2 is a diagram showing a comparison on removal efficiency for Heterosigma akashiwo between Si-QAC modified clays including different nitrogen-containing head groups provided in Example 2 of the present disclosure.

FIG. 3 is a diagram showing a comparison on removal efficiency for Heterosigma akashiwo between Si-QAC modified clays with different aliphatic hydrocarbyl chain lengths provided in Example 3 of the present disclosure.

FIG. 4 is a diagram showing a comparison on removal efficiency for Heterosigma akashiwo between modified clays obtained with different addition proportions of Tetraethyl Orthosilicate (TEOS) provided in Example 4 of the present disclosure.

FIG. 5 is a diagram showing a comparison on removal efficiency for Heterosigma akashiwo between modified clays obtained with different addition proportions of Trimethyl[3-(Trimethoxysilyl)Propyl]Ammonium Chloride (TPTAC) provided in Example 5 of the present disclosure.

FIG. 6 is a diagram showing a comparison on removal effects for different typical red tide algae by an optimized modified clay provided in Example 6 of the present disclosure.

FIG. 7 is a diagram showing comparisons on surface potential and removal efficiency for Heterosigma akashiwo between an optimized modified clay provided in Example 6 of the present disclosure and a common quaternary ammonium compound modified clay after multiple washes.

### DETAILED DESCRIPTION

The method for preparing an organic quaternary ammonium compound modified clay for environmentally friendly and efficient algae removal according to the present disclosure is further described by the following specific examples. These specific examples are helpful to a person skilled in the art to understand the present disclosure more comprehensively, but do not limit the present disclosure in any way.

With the modified clay of the present disclosure, after hydroxyl activation treatment is performed on a surface of an aluminosilicate mineral clay, a silyl-containing organic quaternary ammonium compound (Si-QAC) modifier is added. By regulating a covalent bonding reaction between the silyl in the modifier molecule and an active site on a clay surface, the directional anchoring of the modifier on the clay surface is realized, thereby obtaining an organic quaternary ammonium compound modified clay material with high stability, good ecological safety, and efficient removal capability for common HABs.

### Example 1

The mineral raw material used in the method of the present disclosure is commercially available water-washed kaolin. The clay is treated by different surface hydroxyl activation approaches, and then a silicon-containing organic quaternary ammonium compound (Si-QAC) modifier is added. By regulating the covalent bonding reaction between the silyl in the modifier molecule and the active site on the clay surface, the directional anchoring of the modifier on the clay surface is realized, thereby obtaining the organic quaternary ammonium compound modified clay. The specific preparation method is as follows.

In step 1, activation treatment is performed on the surface of kaolin separately using acid, alkali, and covalently grafted active hydroxyl-containing compound.

(1) Acid activated clay: 10 g of the raw material kaolin is weighed and placed in 200 ml of a hydrochloric acid solution with a concentration of 4 mol/dm³ for reacting at normal temperature for 6 days with shaking by using a shaker. The resulting reaction product is then centrifugally washed three times with an ethanol-water solution at a volume ratio of 1:1, and dried and pulverized for later use.

(2) Alkali activated clay: 10 g of the raw material kaolin is weighed and placed in 200 ml of a sodium hydroxide solution with a concentration of 2 mol/dm³ for reacting at normal temperature for 6 days with shaking by using a shaker. The resulting reaction product is then centrifugally washed three times with an ethanol-water solution at a volume ratio of 1:1, and dried and pulverized for later use.

(3) Covalently grafted hydroxyl compound: 5 g of the raw material kaolin is weighed and placed in a 250 ml three-neck flask, and 80 ml of absolute ethanol, 4.6 ml of ammonium hydroxide, and 1.5 ml of pure water are added to the flask and mixed evenly by ultrasound for 30 minutes. Subsequently, Tetraethyl Orthosilicate (TEOS) is added to a separatory funnel in a mass ratio of kaolin:TEOS of 5:12, and then the TEOS is added to the above three-neck flask containing the activated kaolin mixed solution at a rate of 1 drop/s, while maintaining the mixed solution at 60° C. with continuous stirring for 6 hours. The obtained product is ready for later use.

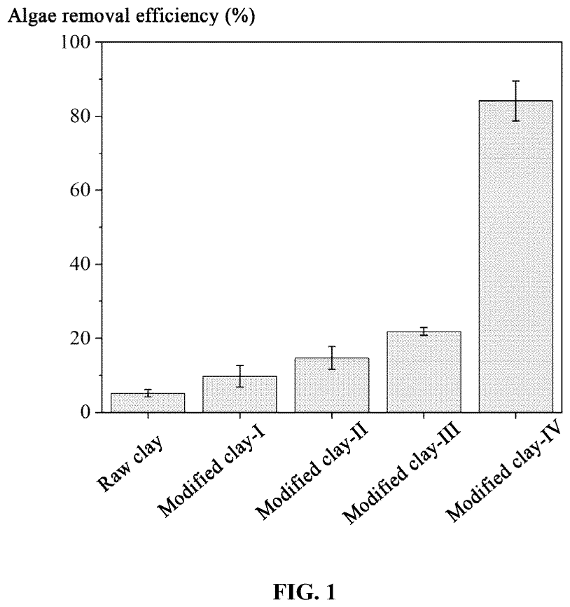

In step 2, 5 g of each of kaolin, alkali activated kaolin, and acid activated kaolin is weighed and placed in a 250 ml three-neck flask, and then 80 ml of absolute ethanol and 1.5 ml of pure water are added to the flask and mixed evenly by ultrasound for 30 minutes. Thereafter, Trimethyl[3-(Trimethoxysilyl)Propyl]Ammonium Chloride (TPTAC) is added to the flask in a ratio of raw clay mineral (Kaolin) to TPTAC (g:mmol) of 5:1, and heated with stirring at 60° C. for 12 hours. After completion of the reactions, the resulting mixed solutions are washed three times with absolute ethanol under the conditions of a centrifugation speed of 5000 r/min and a centrifugation time of 5 minutes to obtain modified clay materials, denoted as modified clay-I, modified clay-II and modified clay-III of the present disclosure (see FIG. 1).

In step 3, a certain amount of Trimethyl[3-(Trimethoxysilyl)Propyl]Ammonium Chloride (TPTAC) is added to the product obtained in the above step 1-(3), and then heated with stirring at 60° C. for 12 hours, where the addition proportion of TPTAC is calculated based on the raw material kaolin, and the ratio of kaolin to TPTAC (g:mmol) is 5:1. After completion of the reaction, the mixed solution is washed three times with absolute ethanol under the conditions of a centrifugation speed of 5000 r/min and a centrifugation time of 5 minutes to obtain a modified clay material, denoted as modified clay-IV.

### Example 2

This example is implemented according to the same steps and conditions as Example 1 for preparing the modified clay-IV, except that the type of the nitrogen-containing group of the Si-QAC added in step 3 is changed. The specific method is as follows.

In step 1, 4 parts of 5 g raw material kaolin are weighed and placed in 250 ml three-neck flasks, respectively; and then 80 ml of absolute ethanol, 4.6 ml of ammonium hydroxide, and 1.5 ml of pure water are added to each flask and mixed evenly by ultrasound for 30 minutes. Subsequently, the flasks are placed in a water bath at 60° C. for heating and stirring.

In step 2, the raw material kaolin and Tetraethyl Orthosilicate (TEOS) are weighed in a mass ratio of 5:12. The weighed TEOS is placed in a separatory funnel, then added to each three-neck flask containing the kaolin mixed solution in step 1 at a rate of 1 drop/s, while maintaining the mixed solution at 60° C. with stirring and heating for 6 hours.

In step 3, Si-QACs (primary ammonium, secondary ammonium, tertiary ammonium, and quaternary ammonium) containing different types of nitrogen-containing head groups are selected. These are respectively 3-Aminopropyltrimethoxysilane (APTES), N-Methyl-3-Aminopropyltrimethoxysilane (MAPTES), [3-(N,N-Dimethylamino)Propyl]Trimethoxysilane (DAPTES), and Trimethyl[3-(Trimethoxysilyl)Propyl]Ammonium Chloride (TPTAC).

The product obtained in step 2 is mixed with the above different Si-QACs separately, and then heated with stirring at 60° C. for 12 h, where the addition proportion of Si-QAC is calculated based on the raw material kaolin, and a ratio of kaolin to a different Si-QAC (g:mmol) is 5:1.

In step 4, the mixed solutions obtained in step 3 are washed three times with absolute ethanol under the conditions of a centrifugation speed of 5000 r/min and a centrifugation time of 5 minutes, thereby obtaining organic quaternary ammonium compound modified clays including different nitrogen-containing head groups.

### Example 3

This example is implemented according to the same steps and conditions as Example 2, except that the aliphatic hydrocarbyl chain length of the Si-QAC added in step 3 is changed. The specific method is as follows.

In step 1, 5 parts of 5 g raw material kaolin are weighed and placed in 250 ml three-neck flasks, respectively; and then 80 ml of absolute ethanol, 4.6 ml of ammonium hydroxide, and 1.5 ml of pure water are added to each flask and mixed evenly by ultrasound for 30 minutes. Subsequently, the flasks are placed in a water bath at 60° C. for heating and stirring.

In step 2, the raw material kaolin and Tetraethyl Orthosilicate (TEOS) are weighed in a mass ratio of 5:12. The weighed TEOS is placed in a separatory funnel, then added to each three-neck flask containing the kaolin mixed solution in step 1 at a rate of 1 drop/s, while maintaining the mixed solution at 60° C. with stirring and heating for 6 hours.

In step 3, Si-QACs with different aliphatic hydrocarbyl chain lengths are selected. That is, two R₂ substituents in the Si-QAC structure are C1, and another R₂ substituents are C1, C6, C12, C14 and C18, respectively. These Si-QACs are Trimethyl[3-(Trimethoxysilyl)Propyl]Ammonium Chloride (TPTAC), Dimethylhexadecyl(3-(Trimethoxysilyl)Propyl)Ammonium Chloride (TPHDAC), Dimethyldodecyl(3-(Drimethoxysilyl)Propyl)Ammonium Chloride (TPDDAC), Dimethyltetradecyl(3-(Drimethoxysilyl)Propyl)Ammonium Chloride (TPTDAC), and Dimethyloctadecyl(3-(Trimethoxysilyl)Propyl)Ammonium Chloride (TPODAC).

The product obtained in step 2 is mixed with the above different Si-QACs separately, and then heated with stirring at 60° C. for 12 h, where the addition proportion of Si-QAC is calculated based on the raw material kaolin, and a ratio of kaolin to a different Si-QAC (g:mmol) is 5:1.

In step 4, the mixed solutions obtained in step 3 are washed three times with absolute ethanol under the conditions of a centrifugation speed of 5000 r/min and a centrifugation time of 5 minutes, thereby obtaining organic quaternary ammonium compound modified clays with different aliphatic hydrocarbyl chain lengths.

### Example 4

This example is implemented according to the same steps and conditions as Example 3, except that the type of Si-QAC is Trimethyl[3-(Trimethoxysilyl)Propyl]Ammonium Chloride (TPTAC), and the addition proportion of Tetraethyl Orthosilicate (TEOS) in step 2 is changed. The specific method is as follows.

In step 1, 6 parts of 5 g raw material kaolin are weighed and placed in 250 ml three-neck flasks, respectively; and then 80 ml of absolute ethanol, 4.6 ml of ammonium hydroxide, and 1.5 ml of pure water are added to each flask and mixed evenly by ultrasound for 30 minutes. Subsequently, the flasks are placed in a water bath at 60° C. for heating and stirring.

In step 2, the raw material kaolin and Tetraethyl Orthosilicate (TEOS) are weighed in mass ratios of 5:3, 5:6, 5:12, 5:24, 5:36, and 5:48, respectively. The weighed TEOS is placed in a separatory funnel, then added to each three-neck flask containing the kaolin mixed solution at a rate of 1 drop/s, while maintaining the mixed solution at 60° C. with stirring and heating for 6 hours.

In step 3, different products obtained in step 2 are mixed with a certain proportion of Trimethyl[3-(Trimethoxysilyl)Propyl]Ammonium Chloride (TPTAC), and then heated with stirring at 60° C. for 12 hours, where the addition proportion of TPTAC is calculated based on the raw material kaolin, and a ratio of kaolin to TPTAC (g:mmol) is 5:2.

In step 4, the mixed solutions obtained in step 3 are washed three times with absolute ethanol under the conditions of a centrifugation speed of 5000 r/min and a centrifugation time of 5 minutes, thereby obtaining modified clays prepared with different addition proportions of TEOS.

### Example 5

This example is implemented according to the same steps and conditions as Example 4, except that a mass ratio of the raw material kaolin to Tetraethyl Orthosilicate (TEOS) is 5:12 in step 2, and the addition proportion of Si-QAC is changed. The specific method is as follows.

In step 1, 6 parts of 5 g kaolin are weighed and placed in 250 ml three-neck flasks, respectively; and then 80 ml of absolute ethanol, 4.6 ml of ammonium hydroxide, and 1.5 ml of pure water are added to each flask and mixed evenly by ultrasound for 30 minutes. Subsequently, the flasks are placed in a water bath at 60° C. for heating and stirring.

In step 2, the raw material kaolin and Tetraethyl Orthosilicate (TEOS) are weighed in the mass ratio of 5:12. The weighed TEOS is placed in a separatory funnel, then added to each three-neck flask containing the kaolin mixed solution at a rate of 1 drop/s, while maintaining the mixed solution at 60° C. with stirring and heating for 6 hours.

In step 3, the products obtained in step 2 are mixed with different proportions of Trimethyl[3-(Trimethoxysilyl)Propyl]Ammonium Chloride (TPTAC), respectively, and then continuously heated with stirring at 60° C. for 12 hours, where the addition proportions of TPTAC are calculated based on the raw material kaolin, and the ratios of Kaolin to TPTAC (g:mmol) are 5:0.3, 5:0.6, 5:1, 5:2, 5:6, and 5:30.

In step 4, the mixed solutions obtained in step 3 are washed three times with absolute ethanol under the conditions of a centrifugation speed of 5000 r/min and a centrifugation time of 5 minutes, thereby obtaining modified clays prepared with different addition proportions of TPTAC.

### Example 6

This example is implemented according to the same steps and conditions as Example 5, except that kaolin:TPTAC (g:mmol) is 5:2, and the number of centrifugal washes is changed. The specific method is as follows.

In step 1, 6 parts of 5 g kaolin are weighed and placed in 250 ml three-neck flasks, respectively; and then 80 ml of absolute ethanol, 4.6 ml of ammonium hydroxide, and 1.5 ml of pure water are added to each flask and mixed evenly by ultrasound for 30 minutes. Subsequently, the flasks are placed in a water bath at 60° C. for heating and stirring.

In step 2, in a mass ratio of kaolin:TEOS of 5:12, a certain amount of TEOS is placed in a separatory funnel, then added to each three-neck flask containing the kaolin mixed solution at a rate of 1 drop/s, while maintaining the mixed solution at 60° C. with stirring and heating for 6 hours.

In step 3, the products obtained in step 2 are mixed with a certain proportion of Trimethyl[3-(Trimethoxysilyl)Propyl]Ammonium Chloride (TPTAC) separately, and then continuously heated with stirring at 60° C. for 12 hours, where the addition proportion of TPTAC is calculated based on the raw material kaolin, and the ratio of kaolin to TPTAC (g:mmol) is 5:2.

In step 4, the mixed solutions obtained in step 3 are washed with absolute ethanol for 3, 4, 5, 6, 7, 8, and 9 times under the conditions of a centrifugation speed of 5000 r/min and a centrifugation time of 5 minutes, respectively, thereby obtaining modified clays, denoted as optimized modified clays of the present disclosure.

### Comparative Example 1

2.5 g of kaolin and 0.025 g of cetyl trimethyl ammonium chloride are weighed and placed in 80 ml of deionized water, mixed evenly, cured for 3 hours at a temperature of 60° C., and then washed with absolute ethanol for 3, 4, 5, 6, 7, 8, and 9 times under the conditions of a centrifugation speed of 5000 r/min and a centrifugation time of 5 minutes, thereby obtaining a modified clay material, denoted as a common quaternary ammonium compound modified clay.

### Application Example

The selection and culture process of experimental organisms are as follows: common harmful algal blooms from China's coastal waters are selected as experimental organisms. According to their cell structures and cell sizes, the experimental algae species selected are Hetemsigma akashiwo (H. akashiwo), Pmrocentrum donghaiense (P. donghaiense), and Aureococcus anophagefferens (A. anophagefferens). The conventional algae species are preserved in Key Laboratory of Marine Ecology and Environmental Science, Institute of Oceanography, Chinese Academy of Sciences. The seawater used to cultivate the algae species is taken from the coastal waters of Huangdao District, Qingdao, China, and filtered using a 0.45 μm mixed fiber membrane. Subsequently, the seawater is sterilized using an autoclave with high-temperature steam and supplemented with Li medium for algae species culture. The culture conditions are temperature (20±1°) C and light-to-dark ratio L:D=12 h:12 h.

The specific method for preparing the L₁ medium used for algae species culture is as follows: 1 ml of NaNO₃ with a concentration of 75 g/L, 1 ml of NaH₂PO₄·H₂O with a concentration of 5 g/L, 1 ml of Na₂SiO₃·9H₂O with a concentration of 30 g/L, 1 ml of a trace element solution, and 0.5 mL of a f/2 vitamin solution are added to 950 ml of filtered and sterilized seawater.

The algae removal experiment procedure is as follows: seawater is added to the obtained modified clay material to prepare a 50 g/L modified clay suspension, and then red tide algae (algal cell density of about 1 to 2×10⁶ cells/L) in the middle and late stages of exponential growth is taken as a removal target and placed in a 25 mL colorimetric tube. Then, according to the use concentration of the modified clay, a certain amount of modified clay suspension is pipetted and added to the colorimetric tube containing the algae liquid, and the colorimetric tube is turned upside down for mixing evenly, and then the algae liquid is cultured for 3 hours. Subsequently, the algae liquid 5 cm below the liquid level is pipetted for the measurement of a fluorescence value. The calculation formula of the algae removal efficiency of the modified clay is as follows:

Algae removal efficiency (%)=[1−(in vivo fluorescence value of experimental group/in vivo fluorescence value of control group)]×100%

1) The organic quaternary ammonium compound modified clays prepared by different surface hydroxyl activation methods provided in Example 1 are utilized in removal experiments on H. akashiwo, and the results are as shown in FIG. 1. At the use concentration of 0.1 g/L, the algae removal effect is poor when the raw material kaolin is used alone, with the algae removal efficiency of only 5.1%. The algae removal efficiency of the modified clay-I of the present disclosure which is synthesized by directly modifying the surface of the kaolin with Si-QAC is 9.7%. The algae removal efficiencies of the modified clay-II and clay-III of the present disclosure that are synthesized by activating the surface of the kaolin by an acid or an alkali and then modifying with Si-QAC are 14.6% and 21.8%, respectively. However, the algae removal efficiency of the modified clay-IV of the present disclosure that is synthesized by covalently grafting a silanol-containing compound on the surface of the kaolin and then modifying with Si-QAC is 84.1%. Therefore, it shows that introducing the active silanol compound on the surface of the clay can significantly improve the algae removal efficiency of the modified clay prepared in the present disclosure. Therefore, the treatment of introducing the active silanol compound on the surface of the clay is the optimal surface activation approach in the method of the present disclosure.

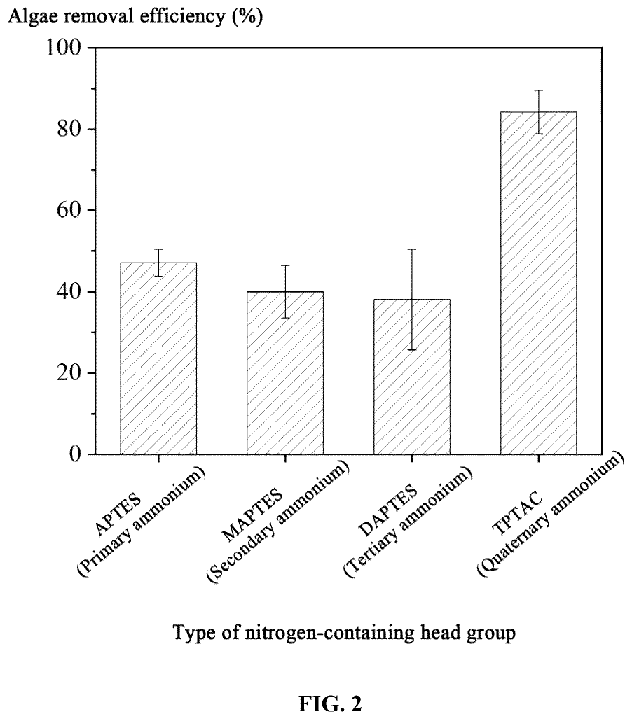

2) The experiment of removing H. akashiwo is conducted by using Si-QAC modified clays including different nitrogen-containing head groups provided in Example 2, and the results are shown in FIG. 2. There is a significant difference in algae removal efficiency between the organic quaternary ammonium compound modified clays including different nitrogen-containing groups, and the sequence of algae removal efficiencies is TPTAC (quaternary ammonium)>APTES (primary ammonium)>MAPTES (secondary ammonium)>DAPTES (tertiary ammonium). Therefore, the best nitrogen-containing head group of the organic quaternary ammonium compound modified clays prepared by the method of the present disclosure is quaternary ammonium.

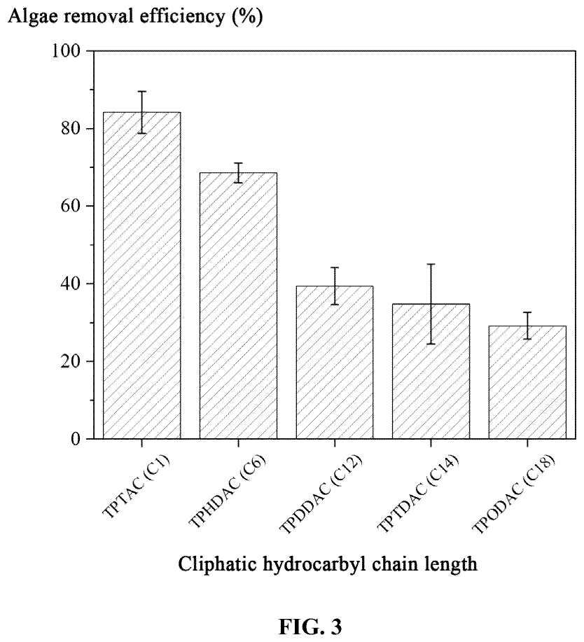

3) The experiment of removing H. akashiwo is conducted by using Si-QAC modified clays with different aliphatic hydrocarbyl chain lengths provided in Example 3, and the results are shown in FIG. 3. When two R₂ substituents in the Si-QAC structure are C1 and another R₂ substituents are C1, C6, C12, C14, and C18, the algae removal efficiency of the synthesized organic quaternary ammonium compound modified clay decreases gradually with the increase of the aliphatic hydrocarbyl chain length. When all three R₂ substituents in the molecular structure of Si-QAC are C1, the algae removal efficiency of the synthesized modified clay is the highest, which is 84.1%. Therefore, Trimethyl[3-(Trimethoxysilyl)Propyl]Ammonium Chloride (TPTAC) containing the quaternary ammonium group and having all three R₂ substituents of C1 is taken as the best Si-QAC in the present disclosure.

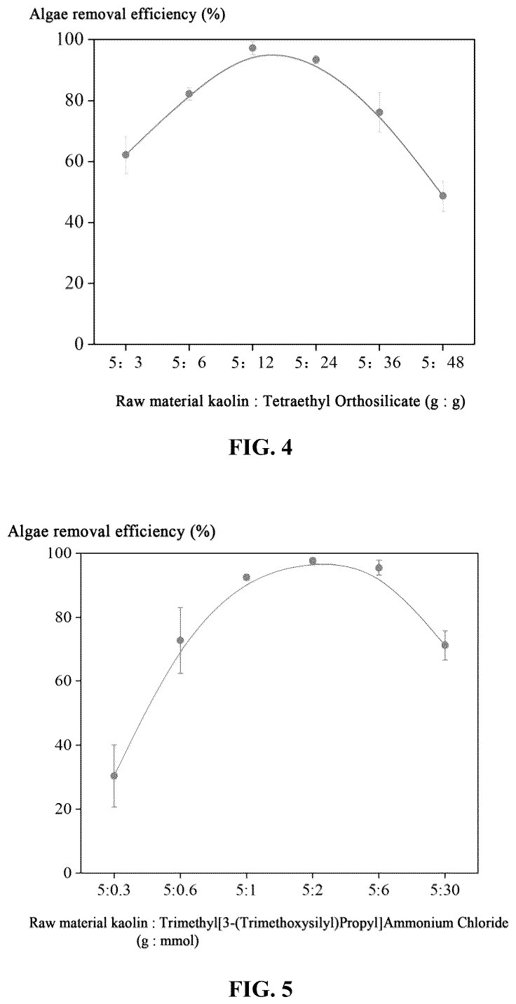

4) The experiment of removing H. akashiwo is conducted by using the modified clays obtained with different addition proportions of Tetraethyl Orthosilicate (TEOS) provided in Example 4, and the results are shown in FIG. 4. The algae removal efficiency of the organic quaternary ammonium compound modified clay synthesized by the method of the present disclosure shows a trend of first increasing and then decreasing with the increase of the addition proportion of TEOS. When the mass ratio of kaolin:TEOS is controlled at 5:12, the organic quaternary ammonium compound modified clay with excellent algae removal performance can be obtained. In this ratio, when the use concentration of the modified clay is 0.1 g/L, the removal efficiency for H. akashiwo may reach 97%.

5) The experiment of removing H. akashiwo is conducted by using the modified clays obtained with different addition proportions of TPTAC provided in Example 5, and the results are shown in FIG. 5. The algae removal efficiency of the synthesized modified clay shows a trend of first increasing and then decreasing with the increase of the addition proportion of TPTAC. When the ratio of kaolin:TPTAC is controlled at 5:1 to 5:6 (g:mmol), the organic quaternary ammonium compound modified clay with excellent algae removal performance can be obtained. In this ratio range, when the use concentration of the modified clay is 0.1 g/L, the removal efficiency for H. akashiwo may reach 90% or above.

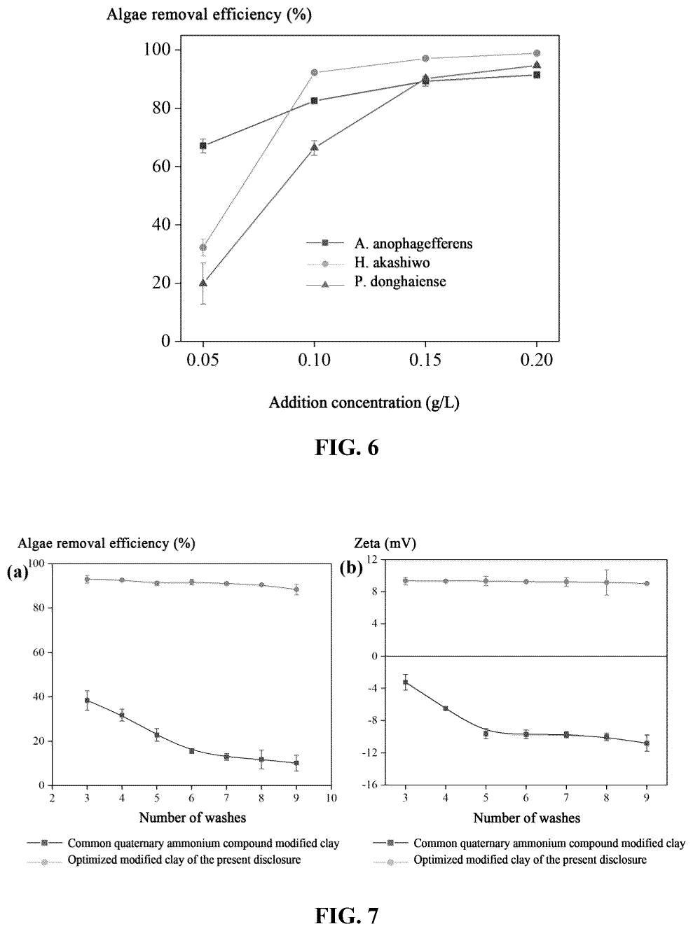

6) The modified clay provided in Example 6 (taking three washes as an example) is set at different use concentrations (i.e. 0.05 g/L, 0.1 g/L, 0.15 g/L, and 0.2 g/L), and the removal experiments are conducted on H. akashiwo, P donghaiense, and A. anophagefferens, respectively, with the results shown in FIG. 6. The organic quaternary ammonium compound modified clay prepared in the present disclosure can achieve a removal efficiency of 90% or above for H. akashiwo at the use concentration of 0.1 g/L. The organic quaternary ammonium compound modified clay prepared in the present disclosure can also achieve a removal efficiency of 90% or above for P. donghaiense and A. anophagefferens at the use concentration of 0.15 g/L.

In order to further analyze the stability of the organic quaternary ammonium compound modified clay prepared in the present disclosure, the removal efficiency for H. akashiwo and the surface potential are compared between the optimized modified clay of the present disclosure provided in Example 6 after being washed for multiple times (i.e., washed with absolute ethanol for 3, 4, 5, 6, 7, 8, and 9 times) and the common quaternary ammonium compound modified clay (Comparative Example 1). The results are shown in FIG. 7. At the use concentration of 0.1 g/L, the algae removal efficiency of the common quaternary ammonium compound modified clay after 3 centrifugal washes is 38%, and the surface potential is −3.2 mV. Moreover, with the increase of the number of centrifugal washes, the algae removal efficiency and surface potential of the common quaternary ammonium compound modified clay gradually decrease. After 9 centrifugal washes, the algae removal efficiency decreases to 10% and the surface potential decreases to −10.8 mV. However, the algae removal efficiency and surface potential of the optimized modified clay in the present disclosure have no significant changes with the increase of the number of centrifugal washes. The algae removal efficiency can be maintained at 90%±2%, and the surface potential can be maintained at 9.15 mV±0.15 mV.

As can be seen from the above, the common quaternary ammonium compound has poor adsorption stability on the surface of the clay and is prone to desorption phenomenon, whereas the present disclosure allows for strong bonding of the organic quaternary ammonium compound molecules on the surface of the clay by grafting and modification by utilizing the valence bond binding action of the silyl in the organosilicon quaternary ammonium compound molecule and the active site on the surface of the clay, thereby obtaining the organic quaternary ammonium compound modified clay material with high stability, good ecological safety, and efficient removal capability for common harmful algal blooms.

What is claimed is:

1. A method for preparing an organic quaternary ammonium compound modified clay for environmentally friendly and efficient algae removal, comprising: performing hydroxyl activation treatment on a surface of a raw clay mineral, and then adding a silyl-containing organic quaternary ammonium compound (Si-QAC) modifier; and obtaining an organic quaternary ammonium compound modified clay by regulating a covalent bonding reaction between the silyl in a modifier molecule and an active site on a clay surface.

2. The method for preparing an organic quaternary ammonium compound modified clay for environmentally friendly and efficient algae removal according to claim 1, wherein the covalent bonding reaction between the silyl in the modifier molecule and the active site on the clay surface refers to a reaction of a mixture of the raw clay mineral and the silyl-containing organic quaternary ammonium compound modifier (g:mmol) in a ratio of 5:(0.3 to 30) for 6 to 24 hours under a heating condition of 40° C. to 80° C. after the hydroxyl activation treatment on the surface of the raw clay mineral.

3. The method for preparing an organic quaternary ammonium compound modified clay for environmentally friendly and efficient algae removal according to claim 1, wherein the silyl-containing organic quaternary ammonium compound (Si-QAC) modifier comprises a silicon-containing group, aliphatic hydrocarbyl, and a nitrogen-containing group.

4. The method for preparing an organic quaternary ammonium compound modified clay for environmentally friendly and efficient algae removal according to claim 3, wherein a structural formula of the silyl-containing organic quaternary ammonium compound (Si-QAC) modifier is as shown by a general formula I, 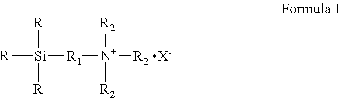
wherein R is C1 to C20 alkoxy or C1 to C20 haloalkoxy; R₁ is C1 to C20 alkyl, C1 to C20 alkoxy, C1 to C20 haloalkoxy, C1 to C20 acyl, or C1 to C20 alkoxycarbonyl; R₂ is H, C1 to C20 alkyl, or C1 to C20 alkoxy; and X⁻ is an anion.

5. The method for preparing an organic quaternary ammonium compound modified clay for environmentally friendly and efficient algae removal according to claim 1, wherein the hydroxyl activation treatment on the clay surface refers to acid or alkali treatment on the clay mineral, or introducing a compound containing active hydroxyl on the clay surface.

6. The method for preparing an organic quaternary ammonium compound modified clay for environmentally friendly and efficient algae removal according to claim 5, wherein the acid or alkali treatment refers to placing the clay mineral in an acid or alkali solution, reacting with shaking for 1 hour or longer at normal temperature or under a heating condition, and then centrifugally washing with ethanol and drying;
the acid solution is prepared from an inorganic acid; and the alkali solution is prepared from one or more of a hydroxide, an oxide, or a salt of an alkali metal or an alkali earth metal.

7. The method for preparing an organic quaternary ammonium compound modified clay for environmentally friendly and efficient algae removal according to claim 5, wherein the introducing a compound containing active hydroxyl on the clay surface comprises: uniformly dispersing the clay mineral in a mixed solution containing absolute ethanol, ammonium hydroxide, and water by ultrasound, slowly adding dropwise a silicon-based precursor capable of reacting to generate the compound containing active hydroxyl to the mixed solution under conditions of heating at 40° C. to 80° C. and stirring, and reacting completely, wherein a mass ratio of the clay mineral to the silicon-based precursor is 5:1 to 5:50; and the silicon-based precursor is prepared from one or more of silanol, siloxane, and a silicate.

8. The method for preparing an organic quaternary ammonium compound modified clay for environmentally friendly and efficient algae removal according to claim 5, wherein the clay mineral is an aluminosilicate mineral.

9. An organic quaternary ammonium compound modified clay for environmentally friendly and efficient algae removal prepared by the method of claim 1, wherein the organic quaternary ammonium compound modified clay with high stability and good ecological safety is prepared by the method of claim 1.

10. Use of the organic quaternary ammonium compound modified clay for environmentally friendly and efficient algae removal of claim 9, wherein the organic quaternary ammonium compound modified clay is used for the removal of harmful algal blooms in an environment.
